(19) United States
(12) Patent Application Publication
(10) Pub. No.: US 2014/0254204 A1
(43) Pub. Date: Sep. 11, 2014

(54) HALF-BRIDGE DC/DC CONVERTER WITH ASYMMETRIC PULSE CONTROLLING PROCESS

(71) Applicant: Chung Shan Institute of Science and Technology, Armaments Bureau, M.N.D, (US)

(72) Inventors: Chien-Min Kao, Taoyuan County (TW); Kuo-Kuang Jen, Taoyuan County (TW); Yu-Min Liao, Taoyuan County (TW); Gwo-Huei You, Taoyuan County (TW)

(73) Assignee: Chung Shan Institute of Science and Technology, Armaments Bureau, M.N.D, Taoyuan Country (TW)

(21) Appl. No.: 13/788,640

(22) Filed: Mar. 7, 2013

(51) Int. Cl. H02M 3/335

(52) U.S. Cl. CPC H02M 3/33507
USPC 363/17

(57) ABSTRACT

A half-bridge dc/dc converter includes a first converter receiving a current and generating a first resonant current; a transformer connecting to the first converter, receiving the first resonant current and generating a second resonant current; and a second converter connecting to the transformer, receiving the second resonant current; wherein the pulse width of currents in the first converter and second convert are adjustable to further stabilize voltage level as well as adjust output power of the transformer for zero voltage switching operation.

### BACKGROUND OF THE INVENTION

1. Field of the Invention

This invention is related to a half-bridge DC/DC converter, and more particularly to a half-bridge DC/DC converter especially using an asymmetric pulse controlling process to achieve zero-voltage-switching (ZVS) operation.

2. Description of the Related Art

Referring to FIG. 1, a conventional two-way, half-bridge isolated DC/DC converter (TWC) is illustrated using current feed-in at battery low voltage side and using voltage feed-in at bus high voltage side. To achieve high efficiency of TWC, the parameter designs and components choice of TWC are pertinently selected, and phase shift methodology is used as control strategy such that power is reciprocally transmitted. The way of control is mainly using a generated resonance between resonant inductances and switches to obtain ZVS behavior, via altering the signal phase shift at low voltage side and high voltage side of TWC in order to adjust the converter output power, which uses not additional circuit to stabilize the duty cycle and the switching frequency of TWC in charging or discharging.

A specific value is provided to the TWC for the switching frequency to stabilize the duty cycle of switching signal, and the switching signal is also considered as a complementary signal, and there exists dead time regions of the signal while the switches are on. According to the feedback of output power, a group of shifted signals are able to be generated, which further controls four switches in the TWC circuit such that the steady output voltage is obtained by adjusting the switching signal phases. However this framework is based on previous research, which states the TWC output power Pₒ is related to input voltage (Vᵢₙ), circuit resonant inductance (L_{S}), signal phase-shift (φ₁) and switching frequency (ω), where Pₒ can be expressed as follow:

$${P}_{o} = \frac{{V}_{i n}^{2}}{ω {L}_{s}} \frac{{φ}_{1} ( π - {φ}_{1} )}{π} \qquad ( 1 )$$

According to equation (1), there is a maximum output power occurred in the situation where the input voltage (Vᵢₙ), the resonant inductance (L_{S}) and the switching frequency (ω) are all given, and phase shift (φ₁=90°) is requested. That means, comparing with full-bridge framework, the half-bridge framework loses a half maximum phase shift and a half maximum propagating energy.

Consequently, how to increase the behavior and achieve ZVS operation for the half-bridge framework to raise the converter performance are expected.

### SUMMARY OF THE INVENTION

The invention provides a half-bridge dc/dc converter, which uses a control method of complementary switching signals to obtain a shorter and steady dead time region of the switching signals of the converter circuit. Then, the ZVS operating is achieved by adjusting the pulse width of switching signals while steady voltage and output power of the circuit are simultaneously adjusted.

To approach the aforementioned purpose, a novel circuit is provided, where the circuit includes: a first converter, receiving a current and generating a first resonant current; a transformer, receiving the first resonant current to generating a second resonant current; and a second converter, receiving the second resonant current; wherein the pulse width of the first converter and second convert are adjustable to further stabilize voltage level as well as adjust output power of the circuit for zero voltage switching operation.

### BRIEF DESCRIPTION OF THE DRAWINGS

The invention, as well as its many advantages, may be further understood by the following detailed description and drawings in which:

FIG. 1 is related to a conventional framework, two-way, half-bridge isolated DC/DC converter;

FIG. 2 illustrates the framework of the invention;

FIG. 3 illustrates the flowchart of asymmetric pulse controlling process of the present invention;

FIG. 4 illustrates the schematic diagram of the controlling strategy of the invention;

FIG. 5 illustrates a complete period sequence diagram of the invention circuit (half-bridge dc/dc converter) for discharging mode; and

FIGS. 6˜17 are circuit operation statuses within the complete period sequence diagram for discharging mode of the present invention.

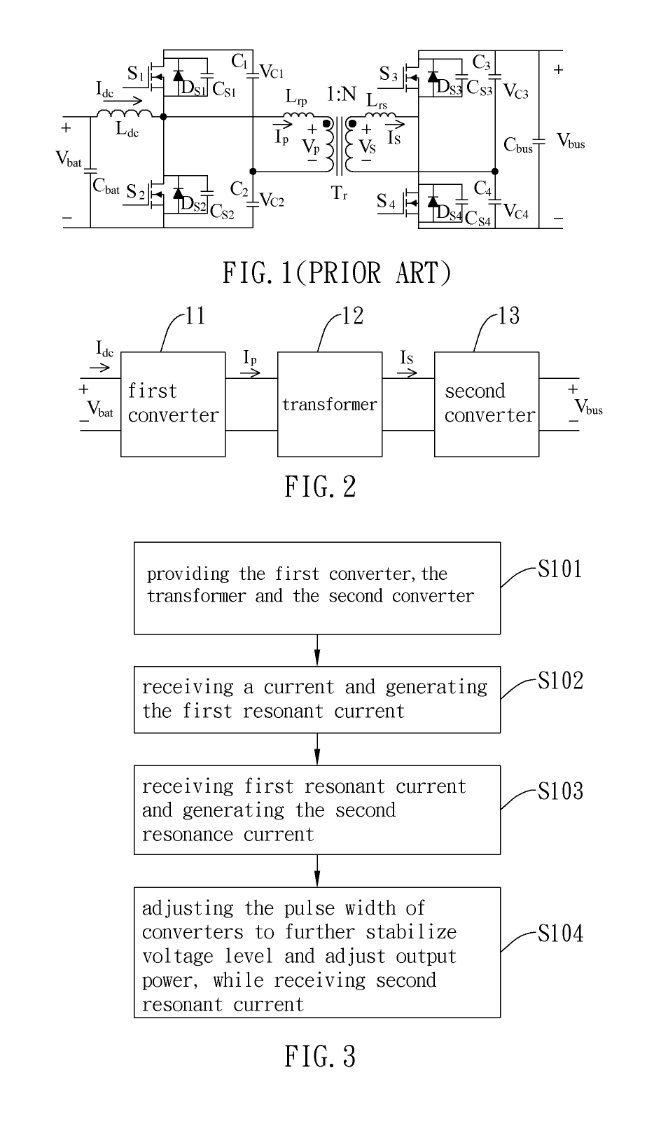

### DETAILED DESCRIPTION OF THE INVENTION

Referring to FIG. 2, a half-bridge dc/dc converter for a preferred embodiment is shown. The half-bridge DC/DC converter includes a first converter 11, a transformer 12 and a second converter 13. The first converter 11 is used to receive a current (I_{dc}) and generate a first resonance current (I_{P}).

The first converter 11 is electrically connected to a primary side of the transformer 12 which receives the resonance current (I_{P}), and then the transformer 12 generates a second resonance current (I_{S}) at a secondary side of the transformer 12. The second converter 13 is electrically connected to the secondary side of the transformer 12 for receiving a second resonance current (I_{S}). To achieve zero voltage switching (ZVS), the primary approach is to adjust pulse width of signals generated by the first converter 11 and the second converter 12 respectively, which further stabilizes voltage level and adjusts output power of half-bridge DC/DC converter.

Referring to FIG. 3, this invention further includes an asymmetric pulse controlling process used for the half-bridge DC/DC converter. The asymmetric pulse controlling process includes:

(step S101) providing the first converter 11, the transformer 12 and the second converter 13, where first converter 11 is electrically connected to a primary side of the transformer 12 and the second converter 13 is electrically connected to a secondary side of the transformer 12;

(step S102) generating a first resonant current, I_{P} while the first converter 11 receives a current;

(step S103) generating a second resonance current Iₛ while the primary side of transformer 12 receives I_{P} while the secondary side of the transformer 12 generates the second resonance current Iₛ; and

(step S104) adjusting pulse width of the first converter signal and second converter signal to further stabilize voltage level and adjust output power of half-bridge DC/DC converter in order to reach ZVS operation while the second converter 13 receives Iₛ.

Referring to FIG. 4, the control strategy of half-bridge DC/DC converter is an asymmetric control method using two complementary switching signals (D and 1-D). That is, a switching signal pulse width decreases while another switching signal pulse width relatively increases. Therefore, the dead time between switching signals is short and steady. In the dead time region, the inductances and parasitic capacitances within the circuit are being resonated without additional circuit to stabilize switching frequency in both two-way modes (charging mode and discharging mode), and the advantage includes both high efficiency as well as simple controlling.

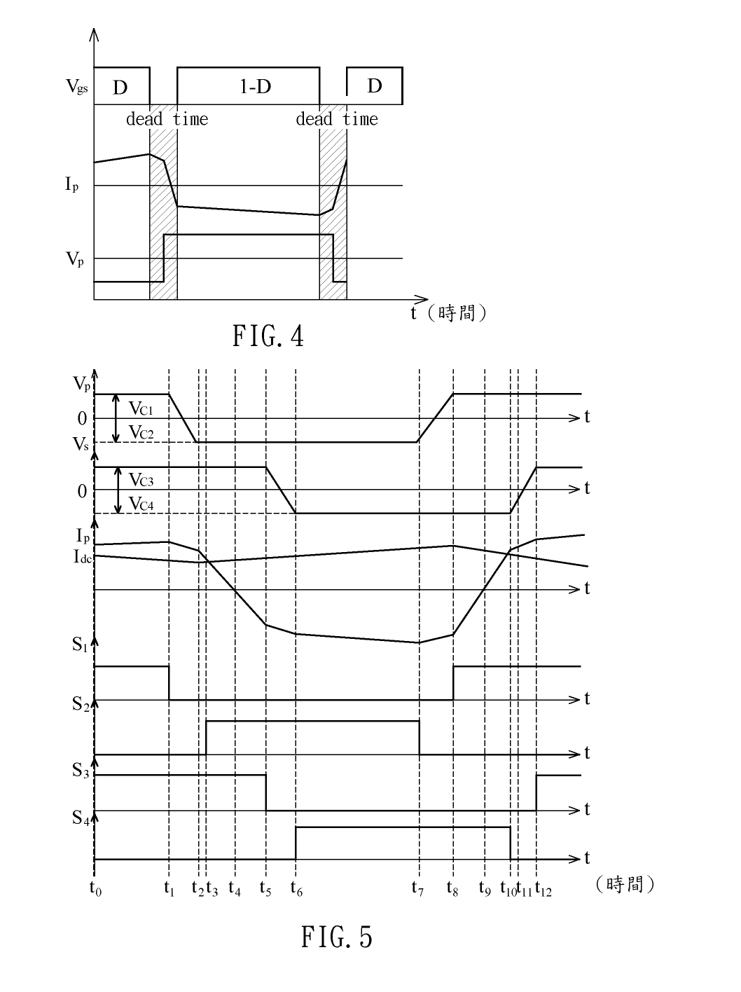

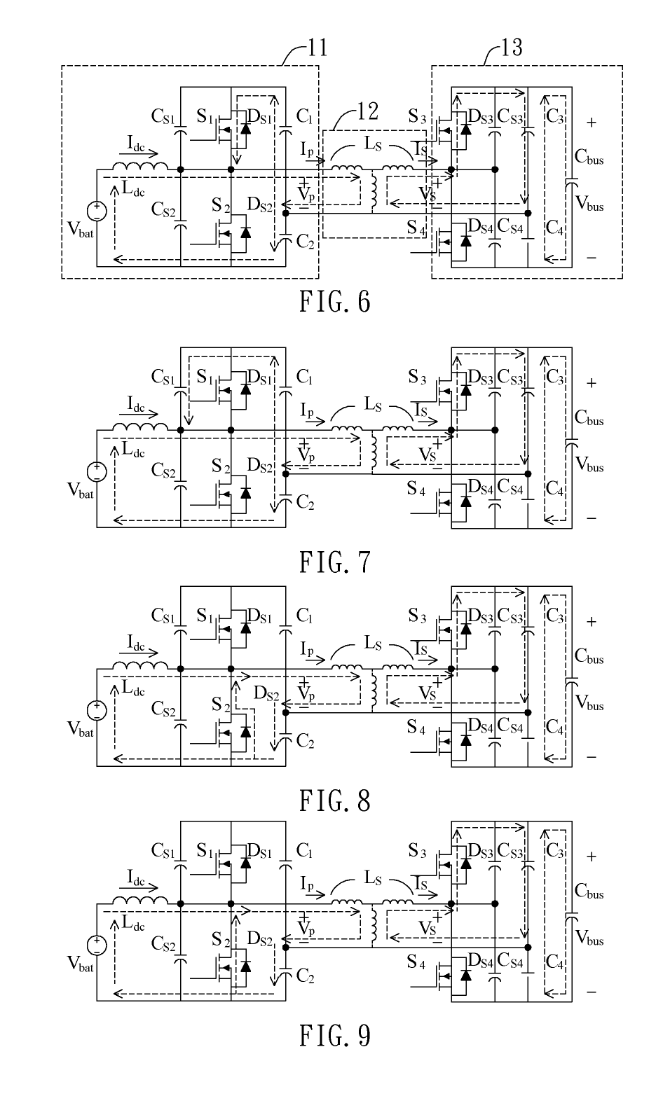

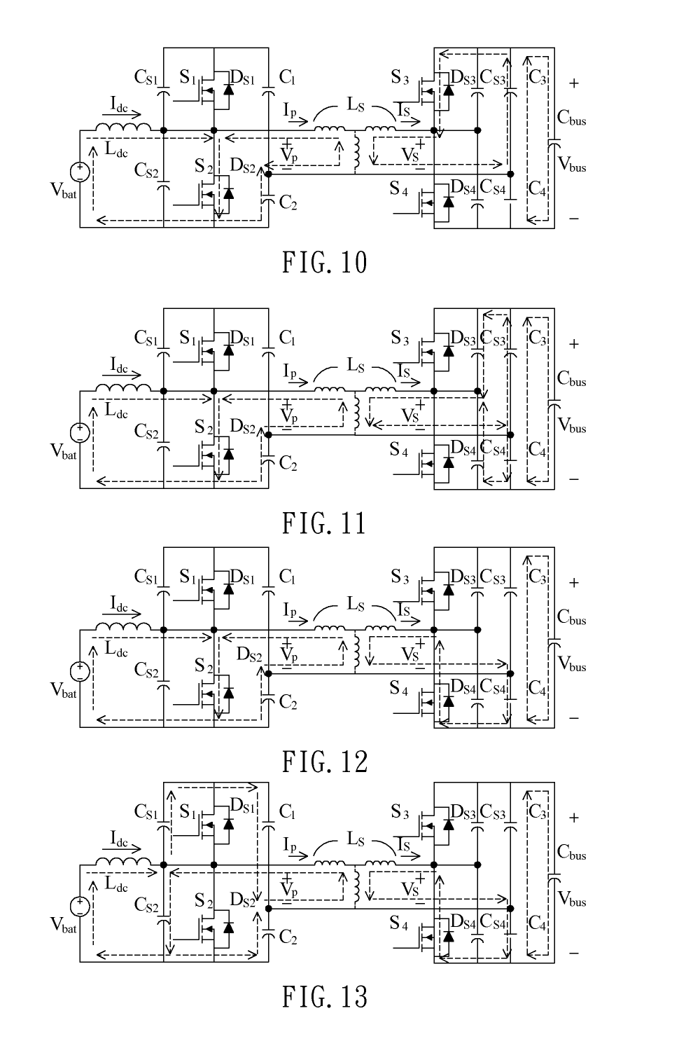

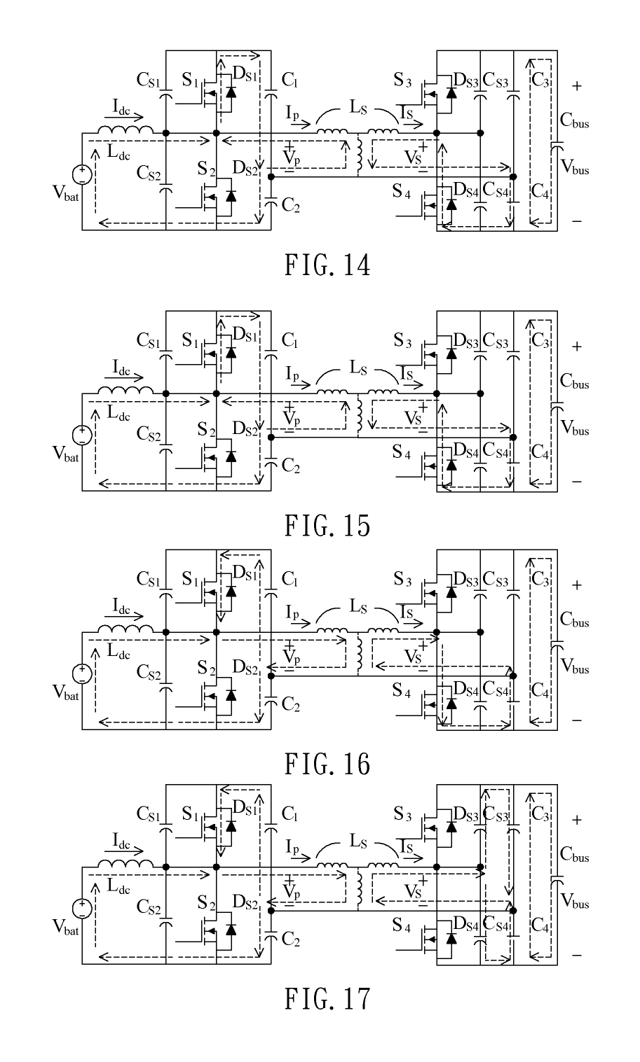

In this preferred embodiment, the half-bridge DC/DC converter has two modes, discharging mode and charging mode. In discharging mode, the circuit operating principle is similar to that of the charging mode, hence only discharging mode will be illustrated here. For detailed description of converter circuit, FIG. 5 illustrates a complete period sequence diagram of the circuit in discharging mode, and FIG. 6 to FIG. 17 illustrate statuses of the circuit operating during the period in discharging mode. To simplify the analysis of circuit, assumptions are made where (a) circuit has been stable; (b) resistance of wire is zero and (c) elements in the circuit are ideal.

Referring to FIG. 6 to FIG. 17, the first converter 11 further includes an input inductance L_{dc}, a first switch S₁, a second switch S₂, a first capacitance C₁, a second capacitance C₂, first serial capacities C_{S1} and second serial capacities C_{S2}, where L_{dc}, C_{S1} and C_{S2} are connected in parallel; C_{S1} and C_{S2} are connected in series; C_{S1}, S₁ and C₁ are connected in parallel; and C_{S2}, S₂ as well as C₂ are connected in parallel. The second converter 13 further includes a third switch S₃, a fourth switch S₄, a third capacitance C₃, a fourth capacitance C₄, third serial capacities C_{S3}, fourth serial capacities C_{S4} and an output capacitance C_{bus}, where C₃ and C₄ are connected in series; C₃ and C_{bus} are connected in parallel; C₃, S₃ and C_{S3} are connected in parallel; and C₄, S₄ as well as C_{S4} are connected in parallel. To realize the circuit statuses description below, please referring FIGS. 6˜17 with FIG. 5.

t₀<t<t₁ Status 1

In this region, switches S₁, S₃ are on. The inductance L_{dc} and capacity C₁ are discharging (releasing energy), and the I_{dc} and I_{C1} are being linearly decreased. Here, the magnitude of I_{P} is equal to the sum of I_{dc}+I_{C1}, and the transformer 12 transfers energy from primary side to secondary side, and the output load continuously absorbs the energy from serial capacities C₃, C₄. The circuit operation is shown in FIG. 6.

t₁<t<t₂ Status 2

For t=t₁, switch S₁ is off, and switch S₃ is still on. Because the resonance current I_{P} has to be continuous, the serial capacitances C_{S1}, C_{S2} and transformer 12 leakage inductance are being resonant. Here, the capacitance C_{S1} is charging, C_{S2} is discharging, load voltage V_{CS2} of C_{S2} begins decreasing from its original value of V_{C1}+V_{C2}, load voltage V_{CS1} of C_{S1} begins increasing from zero. The circuit operation is shown in FIG. 7.

t₂<t<t₃ Status 3

For t=t₂, switch S₂ is off, and switch S₃ is still on. After the resonance process in the status 2, the V_{CS2} is decreased to zero, and parasitic capacitance energy of S₂ is equal to zero, and the parasitic diode D_{S1} is on. So that switch S₂ is on in order to achieve ZVS behavior. The circuit operation is shown in FIG. 8.

t₃<t<t₄ Status 4

In this region, switch S₂, S₃ is on. The inductance L_{dc} is saving energy for charging, and current I_{dc} flowing the inductance L_{dc} is increasing linearly, and the current path is changed in the S₂ section (in status 3, S₂ off and D_{S2} on; in status 4, S₂ on and D_{S2} off). At the beginning of t=t₃, I_{P} is smaller than I_{dc} and decreasing. The energy is propagated from the primary side of the transformer 12 to the secondary side of the transformer 12, where the primary side is loaded with negative voltage, V_{C2} and secondary side are loaded with positive voltage, V_{C3}. For t=t₄, I_{P} is decreasing to zero and turning to negative (as FIG. 5). The circuit operation is shown in FIG. 9.

t₄<t<t₅ Status 4

In this region, switches S₂, S₃ are on, after status 5 Ip is decreasing continually from zero to negative value, that is, the current is reversed in the circuit, and ready for another signal propagating cycle. Here, C₂, C₃ are being discharging, and voltage of C₁ is remained because there is no path for discharging. The circuit operation is shown in FIG. 10.

t₅<t<t₆ Status 6

For t=t₅, switch S₃ is off, and S₂ is still on, and inductance L_{dc} continues to save energy. C_{S3}, C_{S4} and the transformer 12 leakage inductance are being resonated in order to remain the resonant current I_{S} continuous at the secondary side. Here, C_{S3} is charging, C_{S4} is discharging, and the load voltage at the primary side remains the value, V_{C2}. Hence, V_{S} begins to decrease from V_{CS3} to V_{CS4} due to C_{S3} charging and C_{S4} discharging. Finally, S₄ is on while V_{S4} decreases to zero voltage, and the ZVS operation of the transformer 12 is completed. The circuit is shown in FIG. 11.

t₆<t<t₇ Status 7

In this region, switches S₂ and S₄ are on, and inductance L_{dc} continues to save energy that increases L_{dc} linearly. Here, the energy still propagates from the primary side to the secondary side, and output load is provided by the serial capacitances C₃, C₄. The circuit is shown in FIG. 12.

t₇<t<t₈ Status 8

For t=t₇, switch S₂ is off, and S₄ is still on. C_{S1}, C_{S2} and the transformer 12 leakage are being resonated in order to remain the current I_{P} continuous, where C_{S1} is discharging and C_{S2} is charging. The circuit operation is shown in FIG. 13.

t₈<t<t₉ Status 9

For t=t₈, switch S4 is still on, and V_{CS1} decreases to zero due to the resonant current I_{S} absorbing the energy from C_{S1}. Here, the switch S₁ is on because S₁ parasitic capacitance is zero, and parasitic diode D_{S1} is on. The circuit operation is shown in FIG. 14.

t₉<t<t₁₀ Status 10

For t=t₉, the resonant current I_{P} increases from negative value to zero, that is, I_{P} is reversed in the circuit. In this region, S₁ and S₄ are still on, and the inductance L_{dc} maintains to release it's energy that can be treated as a current source of the circuit. The circuit operation is shown in FIG. 15.

t₁₀<t<t₁₁ Status 11

In this region, switches S₂ and S₃ are on, and after status 10 I_{P} keeps increasing to be ready for another signal cycle. The circuit operation is shown in FIG. 16.

t₁₁<t<t₁₂ Status 12

In this region, switch S₄ is off, and S₁ is still on, and the inductance L_{dc} continues to release energy. To remain the resonant current I_{S} continuous at the secondary side, so C_{S3}, C_{S4} and the transformer 12 leakage inductance are resonated. Here, C_{S3} is discharging, C_{S4} is charging, and the load voltage at the primary side remains the value, V_{C1}. Hence, V_{S} begins to increase from −V_{CS4} to V_{CS3} due to C_{S3} discharging and C_{S4} charging. Finally, S₃ is on where V_{S3} decreases to zero voltage, and the ZVS operation of the transformer 12 is completed. The circuit is shown in FIG. 17.

Comparing with prior art, the preferred embodiment of the invention uses asymmetric pulse controlling process to obtain ZVS operation for the transformer 12 and uses much more signal duty cycle. For conventional phase shift of two-way, half-bridge framework, only π/2 range of phase shift is used. To solve the shortage of phase shift, the asymmetric pulse controlling process is used to create a maximum fixed phase shift between forward switches S₁, S₂ and backward switches S₃, S₄ (as shown in FIG. 5, where S₁, S₂, S₃ and S₄ are not synchronized functioning), and the duty cycle is able to be adjusted by the feedback control signal in order to obtain more duty cycle utilization rate and maximum propagating energy in the converter circuit.

This invention provides the half-bridge dc/dc converter with asymmetric pulse controlling process, where the controlling process is mainly using fixed control frequency to adjust the signal pulse width, and the switches (S₁, S₂, S₃, and S₄) operations are being complementary, and the dead time for switches is also fixed. The so-called asymmetric pulse controlling process is a method that is based on the feedback signal, where the upper arm switches (S₁, S₃) increase signal pulse width, oppositely the lower arm switches (S₂, S₄) decrease signal pulse width. With the process, the propagating energy has the maximum value when the switches phase shift is π/2. Therefore, the upper arm switches and lower arm switches operates synchronously but with π/2 phase shifted, and generating a new pulse width signal to stabilize the entire half-bridge dc/dc converter in accordance with the feedback voltage.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A half-bridge dc/dc converter, comprising
a first converter, receiving a current and generating a first resonant current;
a transformer, electrically connecting to the first converter, and receiving the first resonant current to generating a second resonant current; and
a second converter, electrically connecting to the transformer, and receiving the second resonant current;
wherein the pulse width of the first converter and second convert are adjustable to further stabilize voltage level as well as adjust output power of the circuit for zero voltage switching operation.

2. The converter of claim 1, wherein the first converter further comprises an input inductance, a first switch, a second switch, a first capacitance, a second capacitance, a first serial capacitance and a second serial capacitance.

3. The converter of claim 2, wherein the input inductance, the first serial capacitance and the second serial capacitance are connected in parallel, and the first serial capacitance as well as the second serial capacitance are connected in series.

4. The converter of claim 3, wherein the first serial capacitance, the first switch and the first capacitance are connected in parallel, and the second serial capacitance as well as the second capacitance are connected in parallel.

5. The converter of claim 1, wherein the second converter further comprises a third switch, a fourth switch, a third capacitance, a fourth capacitance, a third serial capacitance, a fourth serial capacitance and a output capacitance.

6. The converter of claim 5, wherein the third capacitance and the fourth capacitance are connected in series, and the third capacitance as well as the output capacitance are connected in parallel.

7. The converter of claim 6, wherein the third capacitance, the third switch and the third serial capacitance are connected in parallel, and the fourth capacitance, the fourth switch as well as the fourth serial capacitance are connected in parallel.
